(19) United States
(12) Patent Application Publication
(10) Pub. No.: US 2003/0123486 A1
(43) Pub. Date: Jul. 3, 2003

(54) System and method for utilizing power management functionality between DSL peers

(75) Inventor: Herbert Lyvirn Lacey III, Garner, NC (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: GlobespanVirata Incorporated, Red Bank, NJ

(21) Appl. No.: 09/683,754

(22) Filed: Feb. 11, 2002

Related U.S. Application Data
(60) Provisional application No. 60/343,203, filed on Dec. 31, 2001.

(51) Int. Cl. H04J 1/00

(52) U.S. Cl. 370/485

(57) ABSTRACT

A system and method is provided for integrating the functionality of an interface to a power management driver for a communications system and the communications protocol which negotiates power management transitions. Initially, a driver power management request is received at the UPI component. In response, the UPI component, determines whether a port is open on which to send the state transition request. If it is determined that a port is open, it is next determined whether a suitable power management protocol is available. If it is determined that a port is open and the power management protocol is available, the UPI sends a power management state transition request through the EOC to the remote modem. Next, it is determined whether the remote modem has responded. If it is determined that the remote modem has responded negatively, or failed to respond, the link state protocol interface layer (port manager) is notified, and the port is closed, after which the primary interface is notified, which powers down the communications system and acknowledges the request to the driver. Conversely, if it is determined that the remote modem responded positively, (i.e., the remote modem acknowledged the request to transition power management states), the EOC notifies the port manager, which invokes the negotiated power management state transition, leaves the port open, and then notifies the UPI component, which acknowledges the driver request.

### CROSS REFERENCE TO RELATED APPLICATIONS

This application claims the benefit of U.S. provisional patent application Serial No. 60/343,203 filed Dec. 31, 2001, the disclosure of which is incorporated herein by reference.

### BACKGROUND OF THE INVENTION

The present invention relates generally to electronic communication systems, and in particular, to systems and methods for transmitting and receiving information from such systems over a computer network.

With the increasing popularity of the Internet and other content-heavy electronic communication systems, there has been a substantial need for reliable and affordable high bandwidth mediums for facilitating data transmissions between service providers and their customers. In relation to the requirement that such mediums be affordable to consumers, it was determined that the most cost-effective manner for providing service to customers was by using infrastructure already present in most locations. Accordingly, over recent years, the two such mediums most widely meeting these requirements include the cable television (CATV) and the conventional copper wire telephone systems (plain old telephone system or POTS).

Relating specifically to the adaptation of POTS telephone lines to carry data at high-bandwidth or “broadband” data rates, a number of Digital Subscriber Line (DSL) standards and protocols have been proposed. DSL essentially operates by formatting signals using various Time Domain Equalization techniques to send packets over copper wire at high data rates. A substandard of conventional DSL is known as Asymmetric Digital Subscriber Line (ADSL) and is considered advantageous for its ability to provide very high data rates in the downstream (i.e., from service provider to the user) direction by sacrificing speed in the upstream direction. Consequently, end user costs are minimized by providing higher speeds in the most commonly used direction. Further, ADSL provides a system that applies signals over a single twisted-wire pair that simultaneously supports (POTS) service as well as high-speed duplex (simultaneous two-way) digital data services.

Two of the proposed standards for ADSL are set forth by the International Telecommunications Union, Telecommunication Standardization Section (ITU-T). A first, conventional, ADSL standard is described in ITU-T Recommendation G.992.1 Asymmetric Digital Subscriber Line (ADSL) Transceivers. A second, more recently proposed standard is the G.992.2 or “G.lite” standard, further described in ITU-T Recommendation G.992.2—Splitterless Asymmetric Digital Subscriber Line (ADSL) Transceivers. The G.lite standard is a variant of the G.992.1 standard, with modifications directed primarily to work in a splitterless environment (i.e., without a splitter at the remote user end to separate the voice traffic from the digital data traffic).

FIG. 1 is a simplified block diagram of one embodiment of a typical architecture 100 for a G.992.2 splitterless ADSL system. A user's computer 102 is coupled to an ADSL modem 104 and to a conventional telephone line 106. Similarly, a conventional telephone 108 is also connected to line 106 for communication over voice band frequencies. Upon exiting the customer premises, line 106 relays information on the line to a telecom provider's central office 110. The central office 110 includes a DSL modem and necessary equipment to establish a link to, for example, the Internet or other electronic communication network. As described above, contrary to conventional ADSL systems, splitterless ADSL systems do not require the presence of a splitter at the customer's premises for splitting the digital and voice data prior to deliver to the customer's conventional telephones. As briefly described above, all DSL system operate in essentially the following manner. Initial digital data to be transmitted over the network is formed into a plurality of multiplexed data frames and encoded using special digital modems into analog signals which may be transmitted over conventional copper wires at data rates significantly higher than voice band traffic (e.g., ˜1.5 Mbps (megabits per second) for downstream traffic, ˜150 kbps (kilobits per second) for upstream traffic). The length and characteristics of wire run from a customer's remote transceiver to a central office transceiver may vary greatly from user to user and, consequently, the possible data rates for each user also vary. In addition, the physical channel (i.e., the wires themselves) over which the system communicates also vary over time due to, for example, temperature and humidity changes, fluctuating cross-talk interference sources, and, in splitterless configurations such as those found in G.lite ADSL systems, phones transitioning between on-hook and off-hook states. Consequently, analog DSL signals exists in a noisy, time varying environment. Accordingly, DSL systems use sophisticated training techniques as well as various forms of performance monitoring methodologies to ameliorate these factors.

Relating specifically to performance monitoring, in order to provide maximum performance, systems conforming with the ITU-TADSL (i.e., G.992.1) and G.lite ADSL (i.e., G.992.2 ) standards provide an Embedded Operations Channel (EOC) between the ADSL Transceiver Unit—Central Office (ATU-C) and the ADSL Transceiver Unit—Remote user (ATU-R) located at the customer premises. The EOC enables the ATU-C and ATU-R to send and receive specific commands and messages from each other related to in-service and out-of-service maintenance and for the retrieval of ATU-R status information and performance monitoring parameters. Specifically, the EOC protocol allows the ATU-C to invoke EOC commands and the ATU-R to respond to the commands.

The EOC protocol operates in a repetitive command and response mode. In particular, the ATU-C acts as the master and issues bi-directional EOC messages to the ATU-R. The ATU-R acts as slave and responds to the bi-directional messages issued by the ATU-C by echoing the message back to the ATU-C. Three identical properly-addressed consecutive messages must be received before an action is initiated whether at the ATU-C or the ATU-R. More specifically, EOC channel data is conventionally carried within a single byte or octet (8 bits) of data contained within the Mux (multiplexed) Data Frame referred to as the Sync Byte (SB).

In accordance with the above standards, one category of commands potentially implemented in the EOC of G.lite ADSL systems include a series of power management commands designed to enable the ATU-R to transition between a plurality of power management states and to enable coordination of power management between the ATU's. Such power management functionality facilitates fast re-engagement of communications sessions between the ATU's by providing state information over the EOC.

G.lite ADSL systems require that at least two power states are supported by the DSL layer; L0 (full on), and L3 (no transmit signal). These states are stable, and not transitory, when viewed from a high enough level , i.e. from the device driver layer. For the purpose of this implementation, L0 encompasses all states of a port wherein a signal may appear at the transmitter output. The modem may remain powered or unpowered in L3 (power management is for the benefit of the C0). A variety of power management messages may be exchanged on the EOC and include a power down request (PM_DOWN_REQ) to transition from L0 to L3, a power up request (PM-UP-REQ) to transition from L3 to L0. Possible responsive messages include an acknowledge message (PM-ACK) and a negative acknowledge message (PM_NAK). Accordingly, power management state transitions may be negotiated with the remote modem through the EOC, depending on factors including the particular current annex, remote capability, and local power management feature control.

Unfortunately, the standards for such ADSL systems do not require that the power management EOC commands be implemented by ATU-C's to facilitate the exchange of state information. Further, the standards fail to specifically indicate the manner in which the power management functions on the EOC are to be interfaced with the remainder of the G.lite system (i.e., the UPI layer and the protocol processing), to take advantage of the available benefits. Accordingly, most conventional G.lite systems simply do not implement such functions, thereby failing to recognize the potential benefits of such commands.

Therefore, there is a need for a system and method for integrating the functionality of an interface to a power management driver for a communications system and the communications protocol which negotiates power management transitions.

### SUMMARY OF THE INVENTION

The present invention overcomes the problems noted above, and provides additional advantages, by providing a system and method for integrating the functionality of an interface to a power management driver for a communications system and the communications protocol which negotiates power management transitions. Initially, a driver power management request is received at the UPI component. In response, the UPI component, determines whether a port is open on which to send the state transition request. If it is determined that a port is not open, no protocol operation is possible and the UPI takes the action necessary to effect the power change and notify the driver. However, if it is determined that a port is open, it is next determined whether the power management protocol is available. If not, the port is closed and the UPI powers down the device and notifies the driver. If it is determined that a port is open and the power management protocol is available, the UPI sends a power management state transition request through the EOC to the remote modem. Next, it is determined whether the remote modem has responded.

If it is determined that the remote modem has responded negatively, or failed to respond, the link state protocol interface layer (port manager) is notified, and the port is closed, after which the primary interface is notified, which powers down the communications system and acknowledges the request to the driver. Conversely, if it is determined that the remote modem responded positively, (i.e., the remote modem acknowledged the request to transition power management states), the EOC notifies the port manager, which invokes the negotiated power management state transition, leaves the port open, and then notifies the UPI component, which acknowledges the driver request.

### BRIEF DESCRIPTION OF THE DRAWINGS

FIG. 1 is a simplified block diagram illustrating one embodiment of a G.lite ADSL system incorporating the methodology of the present invention.

FIG. 2 is a flow diagram illustrating one embodiment of a method for interfacing the UPI component with the EOC component to relay power management state information.

FIG. 3 is a message flow diagram illustrating one embodiment of the flow of power management messages between the various components in an ADSL system.

### DETAILED DESCRIPTION OF THE INVENTION

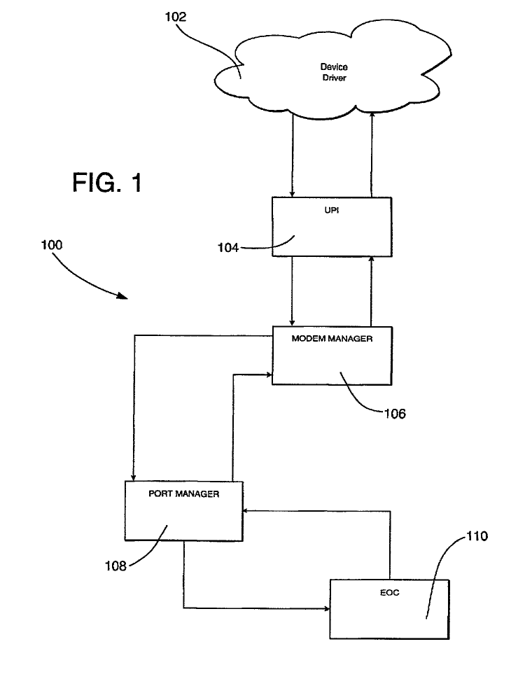

Referring now to the Figures and, in particular, to FIG. 1, there is shown a simplified block diagram illustrating one embodiment of a G.lite ADSL system 100 incorporating the methodology of the present invention. In particular, system 100 includes a UPI (universal programming interface) component 104 for interacting between the ADSL device and the associated device driver 102 within the terminal or computer to which is it connected. The UPI component 104 is the primary interface between the computer and the modem. A modem manager component 106 is operatively connected to the UPI component 104 and further interfaces with a port manager component 108 to determine whether modem ports are open and what mode of operation the system should be in (i.e., handshake mode, training mode, or showtime mode). An EOC component 110 is operatively connected to the port manager component 108 and operates to generate and receive EOC commands at the ports in the manner described above. The interface described below, operates to relay power management state information between the UPI component 104 and above (i.e., the computer or terminal) and the EOC component 110, thereby utilizing the benefits of power management functionalities included within the G.lite standards.

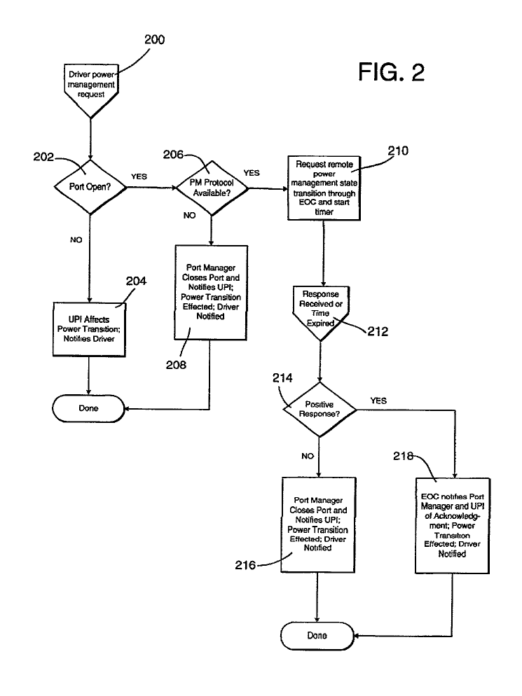

Referring now to FIG. 2, there is shown a flow diagram illustrating one embodiment of a method for interfacing the UPI component with the EOC component to relay power management state information. In step 200, a driver power management request is received at the UPI component. In response, the UPI component, in step 202, determines whether a port is open on which to send the state transition information. If it is determined that a port is not open, no protocol operation is possible and the UPI takes the action necessary to effect the power change and notify the driver in step 204. However, if it is determined that a port is open, it is next determined in step 206 whether the power management protocol is available (i.e., whether the current mode is G.lite ADSL). If not, the port is closed in step 208 and the UPI powers down the device and notifies the driver.

If it is determined in step 206 that the power management protocol is available, the UPI sends a power management state transition request through the EOC to the remote modem (i.e., the ATU-C) and a timer is started in step 210. Next, in step 212, a response is received or a predetermined timeout period expires. In step 214 it is determined whether a positive acknowledgment has been received from the remote ATU. In step 216, if it is determined that the remote modem has responded negatively, or failed to respond after a timeout, the link state protocol interface layer (i.e., Port Manager) is notified, and the port is closed, after which the primary interface is notified, which powers down the communications system and acknowledges the request to the driver. Conversely, in step 218 if it is determined that the remote modem responded positively, (i.e., it acknowledged the request to transition power management states), the EOC notifies the port manager, which invokes the negotiated power management state transition, leaves the port open, and then notifies the UPI component, which acknowledges the driver request.

By providing a clean power management driver interface for the communications system, the details of whether or not the communications system may be able to negotiate a special power management transition with the remote peer communications system is hidden from the device driver, thereby insulating the driver from direct effects caused by failure to support such transitions. Because the driver request is honored regardless of remote response, the driver does not require special knowledge of whether such transitions are supported at the remote end. The present invention may be implemented in any communications system incorporating both host-resident power management device drivers and a specialized protocol capable of negotiating power management transitions with remote devices. Specifically all products capable of operating in accordance with the above-reference G.lite standards.

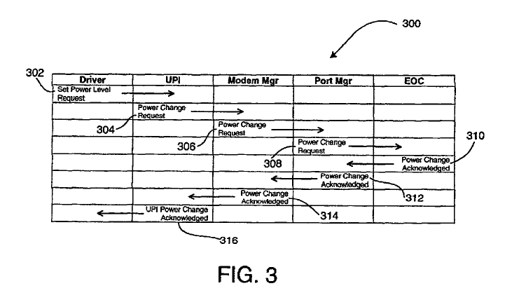

Referring now to FIG. 3, there is shown a message flow diagram 300 illustrating one embodiment of the flow of power management messages between the various components in an ADSL system. In step 302, a set power level request message is sent from the device driver to the UPI component. In response, a power change request message is sent from the UPI component to the Modem Manager component in step 304, indicating that a power management transition has been requested and inquiring as to the availability of a suitable port and protocol. In step 306, a similar power change request message is sent from the Modem Manager component to the Port Manager component where it is determined whether an suitable port is available. In this embodiment, a ports is determined to be available and, in step 308, the Port Manager sends a power change request to the EOC component for protocol determination and transmission to the remote ATU. If a port had not been available, the Port Manager would have returned a power change negative acknowledge message back to the Modem Manager indicating that the requested power transition has not been acknowledged.

If a power management protocol does not exist a negative acknowledge message is returned to the Port Manager indicating such a transition is unacknowleged. However, if a suitable protocol exists, the EOC transmits the state transition request on the wire to the remote ATU. Upon receiving a suitable response from the remote ATU on the EOC, the EOC component, in step 310 sends a power change acknowledge message to the Port Manager. Next, in step 312, the Port Manager forwards a power change acknowledge message to the modem manager, which in turn, in step 314, forwards the acknowledgement message to the UPI. The UPI performs the state transition and notifies the driver with a suitable message in step 316.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

What is claimed is:

1. A method for utilizing power management functionality between DSL peers, comprising the steps of:
receiving a power management request, from a driver component associated with a first DSL device;
sending a power management state transition request through an embedded operations channel to the second DSL device;
determining whether a positive acknowledgement response has been received from the second DSL device; and
effecting a power state transition and acknowledging the power management request to the driver component if it is determined that a positive acknowledgement response has been received from the second DSL device.

2. The method of claim 1, further comprising the steps of:
determining whether a port of the first DSL device is open on which to send state transition information to a second DSL device; and
performing the following steps only if it is determined that a port of the first DSL device is open:
sending the power management state transition request through the embedded operations channel to the second DSL device;
determining whether the positive acknowledgement response has been received from the second DSL device; and
effecting a power state transition and acknowledging the power management request to the driver component if it is determined that a positive acknowledgement response has been received from the second DSL device.

3. The method of claim 2, further comprising the step of:
performing the following steps if it is determined that a port is not open:
effecting the requested power state transition; and
acknowledging the power management request to the driver component.

4. The method of claim 1, further comprising the steps of:
determining whether a power management protocol is available; and
performing the following steps only if it is determined that the power management protocol is available:
sending a power management state transition request through an embedded operations channel to the second DSL device; and
determining whether a positive acknowledgement response has been received from the second DSL device; and
effecting a power state transition and acknowledging the power management request to the driver component if it is determined that a positive acknowledgement response has been received from the second DSL device.

5. The method of claim 4, further comprising the step of:
performing the following steps if it is determined that a positive acknowledgement response has not been received from the second DSL device:
effecting the requested power state transition; and
acknowledging the power management request to the driver component.

6. A method for utilizing power management functionality between DSL peers, comprising the steps of:
receiving a power management request, from a driver component associated with a first DSL device;
determining whether a port of the first DSL device is open on which to send state transition information to a second DSL device;
performing the following steps if it is determined that a port is not open:
effecting the requested power state transition; and
acknowledging the power management request to the driver component;
performing the following steps if it is determined that a port is open:
determining whether a power management protocol is available;
performing the following steps if it is determined that the power management protocol is not available:
closing the port;
effecting the requested power state transition; and
acknowledging the power management request to the driver component;
performing the following steps if it is determined that the power management protocol is available:
sending a power management state transition request through an embedded operations channel to the second DSL device;
determining whether a positive acknowledgement response has been received from the second DSL device;
performing the following steps if it is determined that a positive acknowledgement response has not been received from the second DSL device:
closing the port;
effecting the requested power state transition; and
acknowledging the power management request to the driver component; and
performing the following steps if it is determined that a positive acknowledgement response has been received from the second DSL device:
effecting a power state transition; and
acknowledging the power management request to the driver component.

7. A system for utilizing power management functionality between DSL peers, comprising:
means for receiving a power management request, from a driver component associated with a first DSL device;
means for sending a power management state transition request through an embedded operations channel to the second DSL device;
means for determining whether a positive acknowledgement response has been received from the second DSL device; and
means for effecting a power state transition and acknowledging the power management request to the driver component if it is determined that a positive acknowledgement response has been received from the second DSL device.

8. The system of claim 7, further comprising:
means for determining whether a port of the first DSL device is open on which to send state transition information to a second DSL device; and
means for sending the power management state transition request through the embedded operations channel to the second DSL device only if it is determined that a port of the first DSL device is open;
means for determining whether the positive acknowledgement response has been received from the second DSL device; and
means for effecting a power state transition and acknowledging the power management request to the driver component if it is determined that a positive acknowledgement response has been received from the second DSL device.

9. The system of claim 8, further comprising:
means for effecting the requested power state transition if it is determined that a port is not open; and
means for acknowledging the power management request to the driver component.

10. The system of claim 7, further comprising:
means for determining whether a power management protocol is available;
means for sending a power management state transition request through an embedded operations channel to the second DSL device if it is determined that a power management protocol is available;
means for determining whether a positive acknowledgement response has been received from the second DSL device; and
means for effecting a power state transition and acknowledging the power management request to the driver component if it is determined that a positive acknowledgement response has been received from the second DSL device.

11. The system of claim 10, further comprising:
means for effecting the requested power state transition if it is determined that a positive acknowledgement response has not been received from the second DSL device; and
means for acknowledging the power management request to the driver component.

12. A system for utilizing power management functionality between DSL peers, comprising:
means for receiving a power management request, from a driver component associated with a first DSL device;
means for determining whether a port of the first DSL device is open on which to send state transition information to a second DSL device;
means for effecting the requested power state transition if it is determined that a port is not open:
means for acknowledging the power management request to the driver component if it is determined that a port is not open;
means for determining whether a power management protocol is available if it is determined that a port is open;
means for closing the port if it is determined that the power management protocol is not available;
means for effecting the requested power state transition if it is determined that the power management protocol is not available
means for acknowledging the power management request to the driver component if it is determined that the power management protocol is not available;
means for sending a power management state transition request through an embedded operations channel to the second DSL device if it is determined that the power management protocol is available;
means for determining whether a positive acknowledgement response has been received from the second DSL device;
means for closing the port if it is determined that a positive acknowledgement response has not been received from the second DSL device;
means for effecting the requested power state transition if it is determined that a positive acknowledgement response has not been received from the second DSL device
means for acknowledging the power management request to the driver component if it is determined that a positive acknowledgement response has not been received from the second DSL device;
means for effecting a power state transition if it is determined that a positive acknowledgement response has been received from the second DSL device; and
means for acknowledging the power management request to the driver component if it is determined that a positive acknowledgement response has been received from the second DSL device.

13. A computer readable medium incorporating instructions for utilizing power management functionality between DSL peers, the instructions comprising:
one or more instructions for receiving a power management request, from a driver component associated with a first DSL device;
one or more instructions for sending a power management state transition request through an embedded operations channel to the second DSL device;
one or more instructions for determining whether a positive acknowledgement response has been received from the second DSL device; and
one or more instructions for effecting a power state transition and acknowledging the power management request to the driver component if it is determined that a positive acknowledgement response has been received from the second DSL device.

14. The computer readable medium of claim 13, the instructions further comprising:
one or more instructions for determining whether a port of the first DSL device is open on which to send state transition information to a second DSL device; and
one or more instructions for executing the following instructions only if it is determined that a port of the first DSL device is open:
one or more instructions for sending the power management state transition request through the embedded operations channel to the second DSL device;
one or more instructions for determining whether the positive acknowledgement response has been received from the second DSL device; and
one or more instructions for effecting a power state transition and acknowledging the power management request to the driver component if it is determined that a positive acknowledgement response has been received from the second DSL device.

15. The computer readable medium of claim 14, the instructions further comprising:
one or more instructions for executing the following instructions if it is determined that a port is not open:
one or more instructions for effecting the requested power state transition; and
one or more instructions for acknowledging the power management request to the driver component.

16. The computer readable medium of claim 13, the instructions further comprising:
one or more instructions for determining whether a power management protocol is available; and
one or more instructions for executing the following instructions only if it is determined that the power management protocol is available:
one or more instructions for sending a power management state transition request through an embedded operations channel to the second DSL device; and
one or more instructions for determining whether a positive acknowledgement response has been received from the second DSL device; and
one or more instructions for effecting a power state transition and acknowledging the power management request to the driver component if it is determined that a positive acknowledgement response has been received from the second DSL device.

17. The computer readable medium of claim 16, the instructions further comprising:
one or more instructions for executing the following instructions if it is determined that a positive acknowledgement response has not been received from the second DSL device:
one or more instructions for effecting the requested power state transition; and
one or more instructions for acknowledging the power management request to the driver component.

18. A computer readable medium incorporating instructions for utilizing power management functionality between DSL peers, the instructions comprising:
one or more instructions for receiving a power management request, from a driver component associated with a first DSL device;
one or more instructions for determining whether a port of the first DSL device is open on which to send state transition information to a second DSL device; one or more instructions for executing the following instructions if it is determined that a port is not open:
one or more instructions for effecting the requested power state transition; and
one or more instructions for acknowledging the power management request to the driver component;
one or more instructions for executing the following instructions if it is determined that a port is open:
one or more instructions for determining whether a power management protocol is available;
one or more instructions for executing the following instructions if it is determined that the power management protocol is not available:
one or more instructions for closing the port;
one or more instructions for effecting the requested power state transition; and
one or more instructions for acknowledging the power management request to the driver component;
one or more instructions for executing the following instructions if it is determined that the power management protocol is available:
one or more instructions for sending a power management state transition request through an embedded operations channel to the second DSL device;
one or more instructions for determining whether a positive acknowledgement response has been received from the second DSL device;
one or more instructions for executing the following instructions if it is determined that a positive acknowledgement response has not been received from the second DSL device:
one or more instructions for closing the port;
one or more instructions for effecting the requested power state transition; and
one or more instructions for acknowledging the power management request to the driver component; and
one or more instructions for executing the following instructions if it is determined that a positive acknowledgement response has been received from the second DSL device:
one or more instructions for effecting a power state transition; and
one or more instructions for acknowledging the power management request to the driver component.
